(19) United States
(12) Patent Application Publication
(10) Pub. No.: US 2017/0130285 A1
(43) Pub. Date: May 11, 2017

(54) METHOD FOR PROCESSING A METAL COMPONENT

(71) Applicant: Caterpillar Inc., Peoria, IL (US)

(72) Inventors: Daniel J. Sordelet, Peoria, IL (US); Daniel Cavanaugh, Chillicothe, IL (US); Christopher A. Barnes, Peoria, IL (US); Tomasz J. Chojnacki, Peoria, IL (US)

(73) Assignee: Caterpillar Inc., Peoria, IL (US)

(21) Appl. No.: 14/936,887

(22) Filed: Nov. 10, 2015

(51) Int. Cl. C21D 6/04; C21D 1/28; C21D 9/00; B23K 26/34; B23K 26/00

(52) U.S. Cl. CPC C21D 6/04; B23K 26/34; B23K 26/0006; C21D 9/0068; C21D 1/28

(57) ABSTRACT

A method of processing a metal component is provided. The method includes laser cladding at least one surface of a metal component to obtain a laser cladded metal component having a predefined hardness. The method further includes heat-treating the laser cladded metal component to reduce the predefined hardness of the laser cladded metal component for performing metal working operations thereon. The method also includes cryogenically hardening the laser cladded metal component after the heat-treatment thereof, to induce the predefined hardness to the laser cladded metal component.

### TECHNICAL FIELD

The present disclosure relates to heat-treatment methods of metal components, and more particularly relates to a method for cryogenically processing a metal component.

### BACKGROUND

Laser cladding processes are used to produce various metal components, such as tool inserts. Typically, in a laser cladding process, a cladding material, such as powdered metal, metallic wire, metal strips, etc., is supplied to the metal component at a location at which laser is irradiated to obtain a laser cladded surface on the metal component. The laser cladding process may be used to deposit a laser cladded layer on the metal component to improve various mechanical properties such as corrosion resistance, hardness, etc. The laser cladding process on the metal component may induce stresses in the metal component. Moreover, depositing a hard laser cladded layer on the metal component may cause difficulty to carry out metal working operations, such as machining operations, forming operations, joining operations, etc., thereon. In order to carry out metal working operations, the laser cladded metal components may be subjected to normalizing and tempering processes, as these processes reduce the hardness of the metal components. Alternatively, in order to carry out metal working operations on such metal components, special or expensive tools may be required.

For reference, U.S. Pat. No. 7,827,883 relates to a cutting die and a method of forming the cutting die. The cutting die is formed by scanning a laser beam along a path corresponding to a blade pattern, and by introducing a selected powder to build up an integral blade of high grade, and hard-to-wear material on the relatively softer die body. The final blade shape is machined or produced by EDM or milling. Further hardening by heat-treatment is optional. Other heat sources and cladding materials may also be used.

### SUMMARY

In one aspect of the present disclosure, a method of processing a metal component is provided. The method includes laser cladding at least one surface of a metal component to obtain a laser cladded metal component having a predefined hardness. The method includes heat-treating the laser cladded metal component to reduce the predefined hardness of the laser cladded metal component for performing metal working operations thereon. The method also includes cryogenically hardening the laser cladded metal component after the heat-treatment thereof, to induce the predefined hardness to the laser cladded metal component.

In another aspect of the present disclosure, a method of processing a metal component is provided. The method includes laser cladding at least one surface of a metal component to obtain a laser cladded metal component having a predefined hardness. The method includes heat-treating the laser cladded metal component for reducing the predefined hardness of the laser cladded metal component to obtain a heat-treated laser cladded metal component. The heat-treating of the laser cladded metal component includes normalizing a laser cladded surface of the laser cladded metal component. The heat-treating of the laser cladded metal component includes double tempering the laser cladded surface of the laser cladded metal component. The normalizing and the double tempering reduce the predefined hardness of the laser cladded metal component and cause a formation of austenite from martensite within a microstructure of the laser cladded metal component. The method also includes performing one or more metal working operations on the heat-treated laser cladded metal component to obtain desired dimensions thereof. The method further includes cryogenically hardening the laser cladded metal component after heat-treatment thereof, by immersing the laser cladded metal component in a cryogenic liquid at a temperature below a predefined cryogenic temperature for a preselected duration of time. The cryogenically hardening induces the predefined hardness to the laser cladded metal component and cause a formation of martensite from austenite within the microstructure of the laser cladded metal component

Other features and aspects of this disclosure will be apparent from the following description and the accompanying drawings.

### BRIEF DESCRIPTION OF THE DRAWINGS

FIG. 1 is a schematic block diagram of an illustrative system for processing a metal component;

FIG. 2 is an illustrative Scanning Electronic Microscope (SEM) micrograph of a representative microstructure of a laser cladded metal component, according to an embodiment of the present disclosure;

FIG. 3 is an illustrative SEM micrograph of a representative microstructure of the laser cladded metal component after heat-treating thereof, according to an embodiment of the present disclosure;

FIG. 4 is an illustrative SEM micrograph of a representative microstructure of a heat-treated laser cladded metal component after cryogenic hardening thereof, according to an embodiment of the present disclosure;

FIG. 5 is an illustrative plot of variations in hardness of a material during processing, according to an embodiment of the present disclosure;

FIG. 6 is a flow chart for a method of processing a metal component, according to an embodiment of the present disclosure; and

FIG. 7 is a flow chart for a method of processing a metal component, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

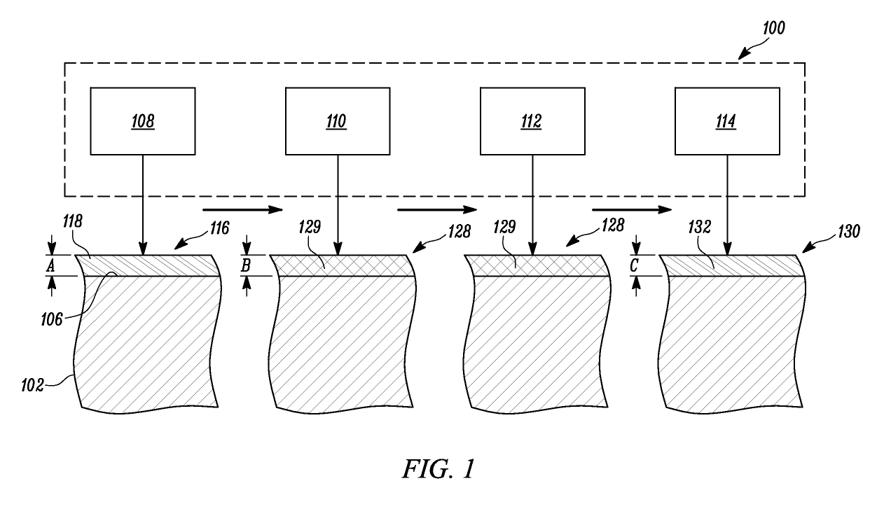

FIG. 1 is a block diagram of an illustrative system 100 that may be used for processing a metal component 102, according to an embodiment of present disclosure. The metal component 102 to be processed has a surface 106. In an embodiment of the present disclosure, the metal component 102 may be a grey cast iron component, and the surface 106 may be a top surface. It may be evident to those skilled in the art that the metal component 102 may be any component such as, a cutting tool, an engine block, a tool shank, a cutting die, a gear and any other part made of various alloys. Examples of such alloys may include, but not limited to, cast iron, alloy steel, carbon steel, carburized steel, tool steel, Nickel (Ni-) alloys, Cobalt (Co-) alloys, Aluminum (Al-) alloys and any other types of metallic alloys known in the art.

The system 100 may be used to obtain a finished metal component 130 by processing the metal component 102, such that the finished metal component 130 has a predefined hardness “H1,” and pre-determined dimensions, and finish. In an example, the system 100 may be used to form a feature, such as brackets, mounting structures, surface recesses, etc., on the surface 106 of the metal component 102. In another example, the system 100 may be used to improve various mechanical properties, such as corrosion resistance, hardness, etc., of the metal component 102. In yet another example, the system 100 may also be used to modify tribological properties, such as wear resistance, of the metal component 102.

The system 100 may include a set of heat-treatment modules for sequentially processing the metal component 102. Specifically, the system 100 may include a laser cladding module 108, a heat-treatment module 110, a metal working module 112 and a cryogenic hardening module 114. Therefore, the laser cladding module 108, the heat-treatment module 110, the metal working module 112 and the cryogenic hardening module 114 are together configured to process the metal component 102 in order to obtain the finished metal component 130 having the predefined hardness “H1”.

The laser cladding module 108 is configured to perform a laser cladding operation upon the metal component 102. The laser cladding operation includes depositing a cladding material on the surface 106 of the metal component 102 in order to obtain a laser cladded metal component 116 having the predefined hardness “H1”. The laser cladding module 108 may include a laser head (not shown) to irradiate a laser onto the surface 106 of the metal component 102, a dispensing member (not shown) to deliver a stream of the cladding material on the surface 106, and a control unit (not shown) communicably coupled to the laser head and the dispensing member. The laser cladding module 108 may be capable of utilizing a cladding material such as steel, nickel alloys, cobalt alloys, cast iron, etc. The cladding material may have a structure and a composition that may undergo microstructural phase change during processing of the metal component 102. In present embodiment, the cladding material is M2 tool steel powder. However, in various other embodiments, any other alloy, selected based on various properties, such as, wear resistance, fatigue strength, and the like may be the cladding material.

The laser head may be configured to irradiate a laser onto the surface 106 of the metal component 102. The laser head may include a laser emitting unit, an oscillating unit, an optical element such as an, optical fibre and a focusing unit. The laser at a specified frequency may be transmitted through the optical element to the laser-focusing unit. At the focusing unit, the laser may be focused, and irradiated to the surface 106 via the laser-emitting unit. The dispensing member may include multiple feeding tubes (not shown) through which the cladding material may be delivered on the surface 106 of the metal component 102.

Specifically, the dispensing member may deliver a stream of cladding material to the metal component 102 at a location at which the laser impinges upon the surface 106. The laser may act as a source of heat which in turn melts the cladding material on the metal component 102 to form a fusion bond between the surface 106 and a molten cladding material lying thereupon. As such, the laser cladded metal component 116 is obtained by providing the laser cladded layer 118 having the predefined hardness “H1” on the metal component 102. In the present embodiment, the predefined hardness “H1” of the laser cladded metal component 116 i.e. grey cast iron component having the laser cladded layer 118 of M2 tool steel, may be in a range of 750 Vickers' Hardness (HV) to 800 Vickers' Hardness (HV).

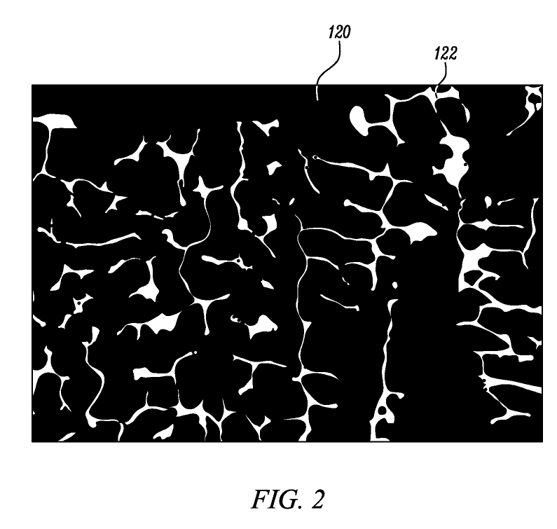

As shown in FIG. 1 the laser cladded layer 118 has a thickness ‘A’ and is provided as a laser cladded surface on top on the the surface 106 of the metal component 102. FIG. 2 is a Scanning Electronic Microscope (SEM) micrograph illustrating representative microstructure of the laser cladded layer 118 of the laser cladded metal component 116. The microstructure of the laser cladded layer 118 includes a first matrix of martensite 120 surrounded by a first pool of Iron carbides 122. The first pool of Iron carbides 122 is uniformly distributed around the first matrix of martensite 120. As known in the art, the martensitic structure imparts high hardness to an iron alloy, for example tool steel. Therefore, it becomes difficult to perform metal working operations on the laser cladded metal component 116. Moreover, the laser cladding operation may induce residual stresses within the laser cladded metal component 116. Further, the laser cladding operations may cause distortions within the laser cladded metal component 116. This may cause a failure of the laser cladded metal component 118 during various machining operations.

Referring back to FIG. 1, the heat-treatment module 110 is configured to perform a heat-treatment operation on the laser cladded metal component 116 to obtain a heat-treated laser cladded metal component 116. In particular, the heat-treatment module 110 reduces the predefined hardness “H1” of the laser cladded metal component 116. Therefore, the heat-treated laser cladded metal component 116 has a hardness “H2” which is less than the predefined hardness “H1”. At hardness “H2”, various metal working operations may be performed on the heat-treated laser cladded metal component 116. Further, the residual stresses within the laser cladded metal component 118 may be released.

In accordance with the present disclosure, the heat-treatment operation includes a normalizing operation and a double tempering operation performed after the normalizing operation. The term “normalizing operation” refers to heating the laser cladded layer 118 to a first predetermined temperature “T1” and thereafter allowing the laser cladded layer 118 to cool to a first cooled temperature “C1”. Further, the term “double tempering operation” refers to heating the laser cladded layer 118 twice to a second predetermined temperature “T2” and thereafter allowing the laser cladded layer 118 to cool to a second cooled temperature “C2”. The second predetermined temperature “T2” is greater than a critical temperature defined for the cladding material.

In present embodiment, the heat-treatment module 110 is configured to selectively heat the laser cladded layer 118 to the first predetermined temperature “T1” and the second predetermined temperature “T2” for a first preselected duration of time “D1” and a second preselected duration of time “D2”, respectively. The first and second predetermined temperatures “T1”, “T2”, the first and second preselected durations of time “D1”, “D2” may be defined based on a material of the metal component 102, and a material and/or thickness of the laser cladded layer 118.

Specifically, during normalizing operation, the heat-treatment module 110 may heat the laser cladded layer 118 to the first predetermined temperature “T1” for the first predetermined duration of time “D1”. In an embodiment of the present disclosure wherein the laser cladded metal component 116 is grey cast iron component and the laser cladded layer 118 is of M2 tool steel, the first predetermined temperature “T1” is 875 degree Celsius and the first preselected duration of time “D1” is 30 minutes. Thereafter, the laser cladded layer 118 is allowed to cool to the first cooling temperature “C1”. In this embodiment, the first cooling temperature “C1” is 550 degree Celsius.

Subsequently, i.e. after the normalizing operation, the heat-treatment module 110 may perform the double tempering operation on the laser cladded layer 118. The heat-treatment module 110 heats the laser cladded layer 118 twice to the second predetermined temperature “T2” for the second preselected duration of time “D1”. In present embodiment, wherein the laser cladded metal component 116 is grey cast iron component and the laser cladded layer 118 is of M2 tool steel, the second predetermined temperature “T2” is 550 degree Celsius and the second preselected duration “D2” of time is 120 minutes. Thereafter, the laser cladded layer 118 is allowed to cool to the second cooling temperature “C2”.

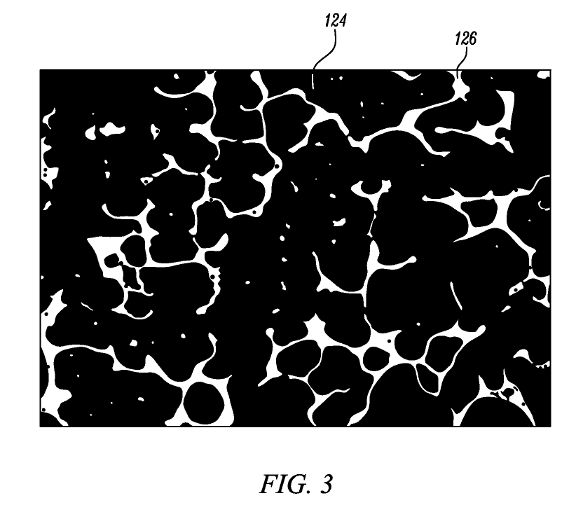

In present embodiment, when an iron alloy is heat-treated to the first and the second temperatures “T1”, “T2” in martensitic range (shown in FIG. 3) for the first and second preselected durations of time “D1”, “D2” respectively, crystal structure of the iron alloy substantially changes to an austenitic structure. FIG. 3 illustrates a SEM micrograph illustrating representative microstructure of the laser cladded layer 118 after performing the heat-treatment operation. The microstructure includes a matrix of austenite 124 surrounded by a pool of Iron carbides 126. The pool of Iron carbides 126 is scattered around the matrix of austenite 124.

Conversion of maternistic structure to austenitic structure may cause a reduction in hardness of the laser cladded layer 118 from the predefined hardness “H1” to the hardness “H2”. As such, the heat-treated laser cladded metal component 128 having the hardness “H2” is obtained. In present embodiment, the hardness “H2” may vary in a range of 550 HV to 600 HV. Further, the heat-treated laser cladded component 128 may include a heat-treated laser cladded layer 129 having a thickness ‘B’. In an embodiment, the thickness ‘B’ may be equal to the thickness ‘A’ of the laser cladded layer 118.

Referring back to FIG. 1, the metal working module 112 is configured to perform one or more metal working operation on the heat-treated laser cladded metal component 128 to obtain desired dimensions. In an embodiment, the metal working operations may include, but not limited to, turning operation, drilling operation, boring operation, surface finishing operation and the like. Accordingly, the metal working module 112 may include one or more tools configured to perform metal working operations.

Referring back to FIG. 1, the cryogenic hardening module 114 is configured to induce the predefined hardness “H1” to the heat-treated laser cladded metal component 128. In particular, the cryogenic hardening module 114 cools the heat-treated laser cladded metal component 128 to a third temperature “T3” below a predefined cryogenic temperature for a third preselected duration of time “D3” to harden the heat-treated laser cladded metal component 128. In the present embodiment, wherein the laser cladded metal component 116 is grey cast iron component and the laser cladded layer 118 is of M2 tool steel, the cryogenic module 114 increases the hardness of the heat-treated laser cladded metal component 128 to a range of 750 HV to 800 HV. Further, the predefined cryogenic temperature may be less than or equal to − (minus) 196 degree Celsius and the third preselected duration “D3” of time is 30 minutes.

In an embodiment, the heat-treated laser cladded metal component 128 may be cooled to the third temperature “T3” by immersing in a cryogenic liquid. Alternatively, a jet of the cryogenic liquid may be applied on the heat-treated laser cladded metal 128 to obtain the third temperature “T3”. Further, the cryogenic liquid may be one of liquid nitrogen and liquid helium.

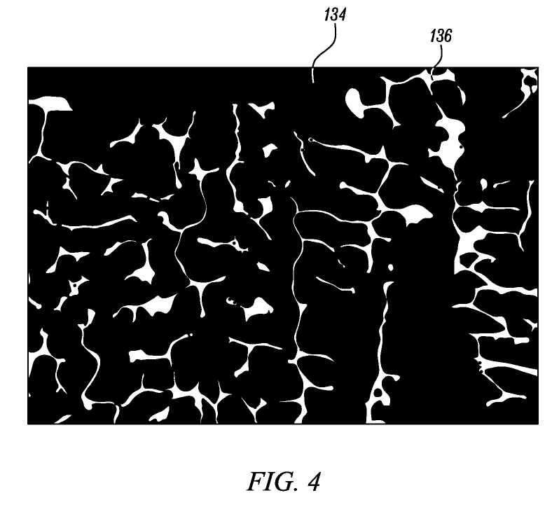

By immersing the heat-treated laser cladded metal component 128 in the cryogenic liquid, austenitic crystal structure (shown in FIG. 3) changes to a substantial martensitic crystal structure (shown in FIG. 4). In present embodiment, when an iron alloy, for example tool steel, is exposed to the third temperature “T3” for the third duration of time “D3”, carbon atoms have insufficient time to diffuse out of the austenite, such that iron-base matrix transforms to martensite. Transformation of austenite to martensite begins at a martensite start temperature of a particular iron alloy. When the iron alloy cools further and reaches a martensite finish temperature, most of the austenite transforms into martensite. Referring to FIG. 4, a SEM micrograph illustrating representative microstructure the heat-treated laser cladded metal component 128 after cryogenic hardening is shown. The microstructure includes a second matrix of martensite 134 surrounded by a second pool of Iron carbides 136. The second pool of Iron carbides 136 is uniformly distributed around the second matrix of martensite 134.

As such, the finished metal component 130 having the substantially martenisitic microstructure (shown in FIG. 4) similar to the microstructure of laser cladded metal component 116 (shown in FIG. 2) is formed. Conversion of austenitic structure to martenisitic structure may result in desired increase in the hardness “H2” to predefined hardness “H1”. Therefore, the finished metal component 130 having the predefined hardness “H1” is obtained. Further, the finished metal component 130 may include a cryogenic hardened layer 132. The cryogenic hardened layer 132 may have a thickness ‘C’ equal to the thickness ‘A’ of the laser cladded layer 118.

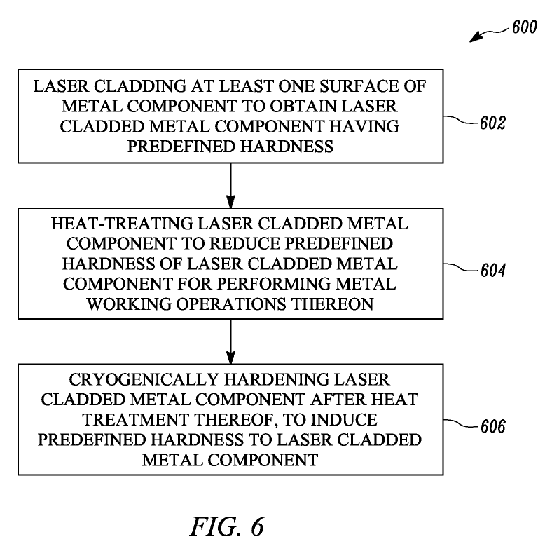

FIG. 6 is an illustrative plot of variation in hardness of the cladding material during processing of the metal component 104, according to an embodiment of the present disclosure. A horizontal axis of the illustrative plot denotes the distance from top of laser clad in mm, i.e. the thickness of the cladding. A vertical axis of the illustrative plot denotes the hardness of the component (in HV). In particular, a plot of variation in hardness within each of the laser cladded layer 118, the heat-treated laser cladded layer 129, and the cryogenic hardened layer 132 is shown. The variations of hardness within the laser cladded layer 118 and heat-treated laser cladded layer 129 are illustrated by a first line “P1”, and a second line “P2”, respectively. Further, upon heat-treating the laser cladded metal component 116, the hardness “H2” (indicated by second first line “P2”) of the laser cladded layer 118 may lie within a range of 550 HV to 600 HV. Thus, various metal working operations may be performed on the heat-treated laser cladded layer 118 in order to obtain the desired dimensions, desired finish etc.

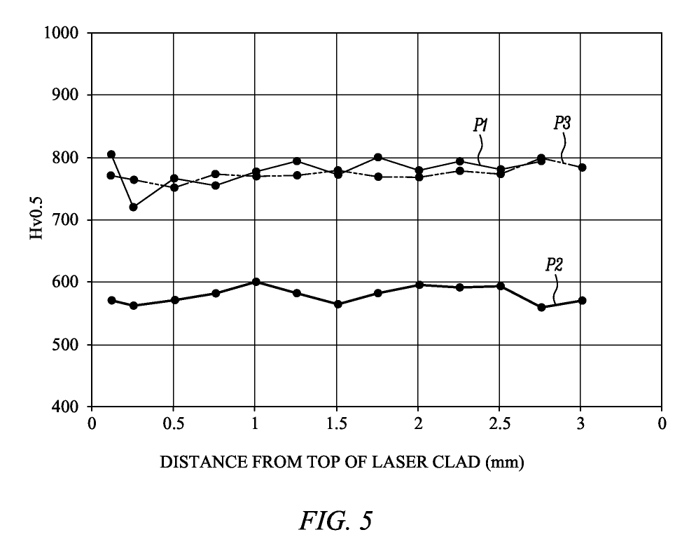

Further, a third line “P3” illustrates the variations of hardness within the cryogenic hardened layer 132. As shown in FIG. 5, the predefined hardness “H1” (indicated by the first line “P1”) of the laser cladded layer 118 varies within a range of 720 HV to 810 HV. Therefore, upon cryogenically hardening the heat-treated laser cladded metal component 128, the predefined hardness “H1” (indicated by the third line “P3”) of the cryogenic hardened layer 132 is obtained within a range of 750 HV to 800 HV.

It may be evident to those skilled in the art, that the system 100 may use the cladding material of any alloy that exhibits microstructural phase transformations during the processing. The cladding material may exhibit other microstructural phase transformations for example crystallographic transitions, during processing of the metal component 102. Specifically, the cladding material may undergo a microstructural phase transformation during the heat treatment operation that may reduce the predefined hardness “H1” of the laser cladded metal component 116. Subsequently, upon cryogenically hardening, the heat treated metal component 116 may undergo a reverse microstructural transformation to regain the predefined hardness “H1”.

The system 100, as described above, is exemplary in nature, and variations are possible within the scope of the present disclosure. For example, the system 100 may also include a controller configured to control and/or regulate the various described modules in order to obtain the finished metal component 130. The system 100 may be configured to use the cladding material of any alloy that exhibits microstructural phase transformation during the heat treatment operation and cryogenic hardening. Moreover, the first predetermined temperature “T1” and the second predetermined temperature “T2” along with the first and second preselected durations of time “D1”, “D2” may also be suitably chosen based on the alloy of the metal component 102 and the cladding material.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims

### INDUSTRIAL APPLICABILITY

FIG. 6 illustrates a method 600 for processing a metal component 102, in accordance with an embodiment of the present disclosure. For purposes of the present disclosure, embodiments disclosed in conjunction with FIGS. 1 to 5 may be considered as being pursuant to the method 500 of FIG. 5. Therefore, for sake of brevity, recapitulation of aspects disclosed in conjunction with FIGS. 1 to 6 has been omitted when rendering steps 502-506 that are associated with the method 600.

Referring to FIG. 6, at step 602, the method 600 for processing a metal component 100 includes laser cladding at least one surface 106 of a metal component 102 to obtain a laser cladded metal component 116 having a predefined hardness “H1”. Referring to FIG. 5, the range of predefined hardness “H1” (indicated by first curve “P1”) is 750 HV to 820 HV. At step 504, the method 500 includes heat-treating the laser cladded metal component 118 to reduce a hardness of the laser cladded metal component 116 for performing metal working operations thereon. In an embodiment, the heat-treating may include normalizing and double tempering the laser cladded layer 118 of the laser cladded metal component 116. As illustrated in FIG. 5, normalizing and double tempering of the laser cladded metal component 116 reduces the predefined hardness “H1” (indicated by first line “P1”) of the laser cladded metal component 116 to the hardness “H2” (indicated by second line “P2”). Specifically, normalizing and double tempering of the laser cladded metal component 116 (i.e. grey cast iron component with the laser cladded layer 118 of M2 tool steel) reduces hardness of the laser cladded metal component 116 to a range of 550 Vickers' Hardness (HV) to 600 Vickers' Hardness (HV). Further, heat-treating the laser cladded metal component 116 also relives residual stresses and distortions induced in the laser cladded metal component 116 due to laser cladding. Therefore, various metal working operations may be conveniently performed on the heat-treated laser cladded layer 129 in order to obtain the desired dimensions and finish, once hardness of the laser cladded metal component 116 has reduced to range of 550 Vickers' Hardness (HV) to 600 Vickers' Hardness (HV).

At step 606, the method 600 includes cryogenically hardening the laser cladded metal component 116 after the heat-treatment thereof, to obtain the predefined hardness “H1” (indicated by third line “P3”). In an embodiment, the method 500 may include immersing the laser cladded metal component 116 in a cryogenic liquid at a temperature “T3” below a predefined cryogenic temperature for a preselected duration of time “D3”. Referring to FIG. 5, cryogenically hardening the heat-treated laser cladded metal component 128 increases the hardness “H2” to the predefined hardness “H1”. Specifically, the , cryogenically hardening of the laser cladded metal component 116 e.g. grey cast iron component and the laser cladded layer 118 e.g. M2 tool steel, increases hardness to a range between 750 HV to 800 HV.

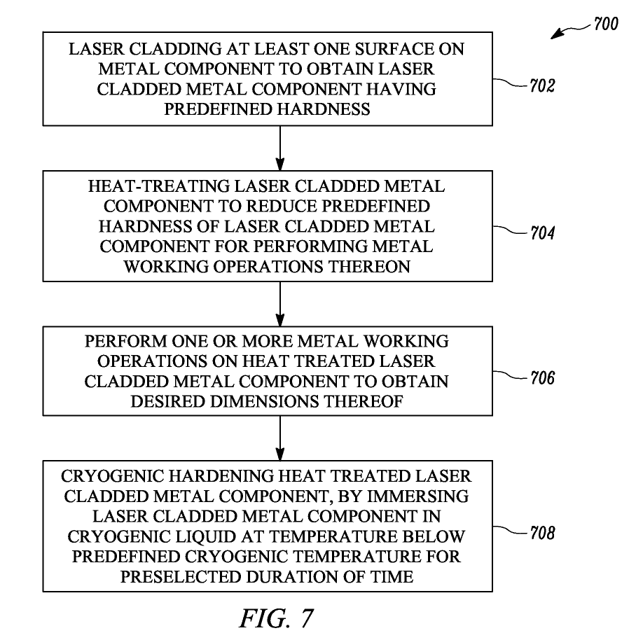

FIG. 7 illustrates another method 700 for processing a metal component 102, in accordance with an embodiment of the present disclosure. Referring to FIG. 7, at step 702, the method 700 includes laser cladding at least one surface 106 on the metal component 102 to obtain a laser cladded metal component 116 having a predefined hardness “H1”. At step 704 the method 700 includes heat-treating the laser cladded metal component 116 for reducing the predefined hardness “H1” of the laser cladded metal component 116 to obtain a heat-treated laser cladded metal component 128. The heat-treating of the laser cladded metal component 116 includes normalizing and double tempering a laser cladded layer 118 of the laser cladded metal component 116. Referring to FIG. 6, normalizing and double tempering reduces the predefined hardness “H1” of the laser cladded metal component 116 and cause a formation of austenite (shown in FIG. 3) from martensite (shown in FIG. 2) within a microstructure of the laser cladded metal component 116. At step 706 the method includes performing one or more metal working operations on the heat-treated laser cladded metal component 128 to obtain desired dimensions thereof

At step 708, the method 700 includes cryogenic hardening the laser cladded metal component 116 after heat-treating thereof, by immersing the laser cladded metal component 116 in a cryogenic liquid at a temperature “T3” below a predefined cryogenic temperature for a preselected duration of time “D3”. The cryogenically hardening imparts the predefined hardness “H3” to the laser cladded metal component 116 and cause a formation of martensite (shown in FIG. 4) from austenite (shown in FIG. 3) within the microstructure of the laser cladded metal component 116.

With use of the present disclosure, the metal component 102 may be processed in order to obtain the finished metal component 130 having the predefined hardness “H1”. At first, the metal component 102 is laser cladded to obtain the laser cladded metal component 116 having the predefined hardness “H1”. After performing the laser cladding operation on the metal component 102, heat-treating is performed on the laser cladded metal component 116 to reduce the predefined hardness “H1” such that various metal working operations may be easily performed with use of conventional and inexpensive tools. Heat-treating the laser cladded metal component 116 also relives residual stresses induced in the laser cladded metal component 116 due to laser cladding. Further, cryogenic hardening is performed on the heat-treated laser cladded metal component 128 to obtain the finished metal component 130 having the predefined hardness “H1”.

While aspects of the present disclosure have been particularly shown and described with reference to the embodiments above, it will be understood that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

What is claimed is:

1. A method of processing a metal component, the method comprising:
laser cladding at least one surface of a metal component to obtain a laser cladded metal component having a predefined hardness;
heat-treating the laser cladded metal component to reduce the predefined hardness of the laser cladded metal component for performing metal working operations thereon; and
cryogenically hardening the laser cladded metal component after the heat-treatment thereof, to induce the predefined hardness to the laser cladded metal component.

2. The method of claim 1 further comprising, forming austenite from martensite within a microstructure of the laser cladded metal component.

3. The method of claim 1 further comprising:
normalizing a laser cladded surface on the laser cladded metal component; and
double tempering the laser cladded surface on the laser cladded metal component.

4. The method of claim 3, wherein normalizing and double tempering of the laser cladded metal component reduces the hardness of the laser cladded metal component to a range of 550 Vickers' Hardness (HV) to 600 Vickers' Hardness (HV).

5. The method of claim 3 further comprising, keeping the laser cladded metal component at a first predetermined temperature above a critical temperature of the laser cladded metal component for a preselected duration of time.

6. The method of claim 5, wherein the first predetermined temperature is 875 degree Celsius, and the preselected duration of time is 30 minutes.

7. The method of claim 1 further comprising, keeping the laser cladded metal component at a second predetermined temperature range lesser than a critical temperature of the laser cladded metal component twice, for a second preselected duration of time.

8. The method of claim 7, wherein the second predetermined temperature is 550 degree Celsius and the second predetermined duration is 120 minutes.

9. The method of claim 1 further comprising, immersing the laser cladded metal component in a cryogenic liquid at a temperature below a predefined cryogenic temperature for a preselected duration of time.

10. The method of claim 9 further comprising, forming martensite from austenite within a microstructure of the laser cladded metal component.

11. The method of claim 9, wherein the step of immersing the laser cladded metal component in the cryogenic liquid at the temperature below the predefined cryogenic temperature for the preselected duration of time increases the hardness of the laser cladded metal component to a range of 750 to 800 HV.

12. The method of claim 9, wherein the predetermined cryogenic temperature is less than or equal to minus 196 degree Celsius.

13. The method of claim 9, wherein the preselected duration of time for immersing the laser cladded metal component in the cryogenic liquid at the temperature below the predefined cryogenic temperature is 30 minutes.

14. The method of claim 9, wherein the cryogenic liquid is one of liquid nitrogen and liquid helium.

15. The method of claim 1, wherein laser cladding includes depositing layer of M2 tool steel on a grey cast iron metal component.

16. A method of processing a metal component, the method comprising:
laser cladding at least one surface of a metal component to obtain a laser cladded metal component having a predefined hardness;
heat-treating the laser cladded metal component for reducing the predefined hardness of the laser cladded metal component to obtain a heat-treated laser cladded metal component, the heat-treating of the laser cladded metal component includes:
normalizing a laser cladded surface of the laser cladded metal component; and
double tempering the laser cladded surface of the laser cladded metal component,
wherein normalizing and double tempering reduce the predefined hardness of the laser cladded metal component and cause a formation of austenite from martensite within a microstructure of the laser cladded metal component;
performing one or more metal working operations on the heat-treated laser cladded metal component to obtain desired dimensions thereof; and
cryogenic hardening the heat-treated laser cladded metal component, by immersing the laser cladded metal component in a cryogenic liquid at a temperature below a predefined cryogenic temperature for a preselected duration of time, wherein the cryogenically hardening induces the predefined hardness to the laser cladded metal component and causes a formation of martensite from austenite within the microstructure of the laser cladded metal component.

17. The method of claim 16 further comprising, keeping the laser cladded metal component at a first predetermined temperature above a critical temperature of the laser cladded metal component for a preselected duration of time.

18. The method of claim 16 further comprising, keeping the laser cladded metal component at a second predetermined temperature range lesser than the critical temperature of the laser cladded metal component twice for a second preselected duration of time.

19. The method of claim 16, wherein the step of immersing the laser cladded metal component in the cryogenic liquid at the temperature below the predefined cryogenic temperature for the preselected duration of time increases the hardness of the laser cladded metal component to a range of 750 HV to 800 HV.

20. The method of claim 19, wherein the predetermined cryogenic temperature is less than or equal to minus 196 degree Celsius and the preselected duration for immersing the laser cladded metal component in a cryogenic liquid at a temperature below a predefined cryogenic temperature is 30 minutes.
